(19) United States
(12) Patent Application Publication
(10) Pub. No.: US 2007/0230542 A1
(43) Pub. Date: Oct. 4, 2007

(54) BIDIRECTIONAL SIGNAL TRANSMISSION SYSTEM

(76) Inventors: Noriyasu Okada, Kawaguchi-shi (JP); Makoto Shidooka, Tokyo (JP); Koji Enomoto, Tokyo (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/689,048

(22) Filed: Mar. 21, 2007

(30) Foreign Application Priority Data
Mar. 29, 2006 (JP) 2006-090268

(51) Int. Cl. H04B 1/00

(52) U.S. Cl. 375/146

(57) ABSTRACT

A bidirectional signal transmission system having an imaging device, a control device for control of the imaging device, and a transmission channel for connecting the imaging device and the control device is disclosed. The imaging device is operatively responsive to receipt of a test signal as output from the control device, for sending the test signal back to the control device. The control device provides control for detecting a delay time spanning from a time point at which the test signal is output to an instant whereat the sendback signal is input thereto.

### INCORPORATION BY REFERENCE

The present application claims priority from Japanese application JP2006-090268 filed on Mar. 29, 2006, the content of which is hereby incorporated by reference into this application.

### BACKGROUND OF THE INVENTION

The present invention relates in general to signal transmission systems and, in more particular, to a bidirectional signal transmission system with cable length detectability.

Data communications systems include a two-way transmission system for bidirectionally transferring multiplexed data of video and audio signals and a control signal(s) between video equipments. An example of such video devices is an imaging device, such as a television (TV) camera, also known as a camera head unit. Another example is a camera control device, called the camera control unit (CCU) or, simply, control device. Usually in this system, a frequency division multiplex (FDM) technique is used for transmission of the data, such as video/audio and control signals, by use of a transfer channel—for example, a triple coaxial or triaxial cable, which is typically referred to as “triax” cable in the art to which the invention pertains.

One typical approach in the triax cable data transfer one approach is to use analog FDM schemes for bidirectional transmission of video, audio and control signals. In the case of analog signal processing, video and audio signals obtainable from any one of the camera head unit and CCU can degrade in characteristics due to influences of in-use cable properties and filter characteristics at the time the frequency division is in process.

A digital video signal multiplex transfer method and apparatus capable of solving this problem are disclosed, for example, in Japanese Patent No. 3390509. An exemplary analog transmission technique is taught by JP-A-4-45675. This technique includes the steps of digitizing video and audio signals at a respective one of the opposite ends of a transfer channel, applying thereto time-division multiplexing (TDM) and time axis compression to thereby generate a send signal consisting essentially of iteration of signal periods and non-signal or “null” periods, and then transferring two send signals in the opposite directions at a time while causing a signal from one-side end of the transfer channel to be sent within a null period of the remaining signal from the other transfer channel end, thereby enabling bidirectional data transmission over a single transfer channel. This technique has already been reduced to practice.

The prior known signal transmission system is designed to use a single triax cable for transmission of several kinds of signals between the camera head unit and CCU, which signals include an ensemble of a primary (mainline) video signal, audio signal and control signal of serial data format to be sent from the camera head unit, a set of returned (sendback) video signal, audio signal and various kinds of control signals of serial data format as sent back from CCU to the camera head unit, and power supply voltage or the like. Obviously, multiplexing these digital video signals for conversion to a serial signal results in likewise expansion of the frequency band required for such signal transmission. This leads to disadvantage as to an unwanted increase in degradation of signal characteristics occurring due to the presence of cable loses of transfer channel and a decrease in data-transferable cable length. In other words, as far as the digital signal transferable distance (i.e., the length of a transfer channel or cable) is concerned, appreciable degradation occurrable in analog transmission does not take place; however, once the cable length goes beyond the digital transferable distance, proper signal reproduction becomes hardly expectable: in the worst case, the system goes into the state that any signals are no longer transferable.

For example, supposing that signals are transferred from the camera head unit at a data rate of about 200 Mbps whereas sendback signals to the camera head unit are at a data rate of about 70 Mbps, the data transfer rate for two-way transmission is about 270 Mbps. Signals with this data rate of 270 Mbps are sendable in a frequency band covering up to 135 MHz.

Triax cables of currently wide use are relatively large in attenuation amount, which is typically about −120 dB per distance of 1 km for transmission of signals with a frequency of 135 MHz. Exceeding this signal frequency, it becomes very difficult to reproduce digital signals transferred. To perform transmission and reception of digital signals at a practically acceptable attenuation of about −83 dB with a certain degree of margin included therein, the length of a triax cable therefor is limited to 700 m, or more or less.

A camera system using triax cables is employable for various applications. For example, in the case of a TV broadcast station, the system is used within a studio in many cases. In this situation, the length of a cable is usually 100 m or less so that the attenuation poses no specific problems. However, the camera system is often used in out-of-door environments, such as in the event of live broadcasting of a baseball game, golf match or marathon race. In such case, the distance between the camera head unit and CCU is in excess of 1 km at almost all times. Thus a need is felt to extend a triax cable by disposing one or more interexchange devices with intermediary linkup/relaying functionalities, called the repeaters, as will be described later. To this end, the procedure of installing a camera head starts with approximate calculation of a total distance, followed by setup of an adequate number of triax cables to be serially connected together along the distance. Even in this case, the system is still encounterable with serious problems which follow: the lack of an ability to properly reproduce video images due to possible signal degradation when shooting real scenes, and the sudden loss of on-air video images during broadcasting of a baseball game, golf match, marathon race or else. It is thus desired to provide a signal transmission system that is free from the problems while offering its ability to detect the transfer channel characteristics in an automated way.

In the case of TV cameras being in the outdoor use for live broadcast of sports events, such as a baseball game, golf match or marathon race, the distance between the individual camera head unit and CCU is in excess of 1 km in most cases. This must accompany several risks as to the signal degradation-caused video playback incapability upon shooting of real scenes and the loss of on-air video images, which raise serious problems in practical implementation of the signal transmission system.

### SUMMARY OF THE INVENTION

It is therefore an object of the present invention to provide a signal transmission system capable of steadily transferring camera-shot images with high reliability.

Another object of this invention is to provide a bidirectional signal transmission system operative to detect or “recognize” a cable length upon connection of a camera head and a camera control unit (CCU) and visually display a present state of transfer channel along with the information relating thereto, if any.

In accordance with one aspect of this invention, a bidirectional signal transmission system includes an imaging device, a control device for control of the imaging device, and a transmission channel for connecting the imaging device and the control device. The imaging device has a signal send-back unit for inputting a test signal as output from the control device and for sending the test signal back to the control device. The control device includes a first delay time detector which detects a delay time of from outputting of the test signal to inputting of the signal as sent back thereto.

The bidirectional signal transmission system further includes at least one interexchange device having a second delay time detector operative to detect a delay time between outputting of the test signal from the interexchange device toward the imaging device and inputting of the send-back signal to the interexchange device.

In the signal transmission system, the control device has a transmission channel length detector which detects the length of the transmission channel based on at least delay time information as given from the first delay time detector.

In addition, in the transmission system, the control device further includes a display unit for displaying the length of the transmission channel based on an output of the transmission channel length detector.

In the transmission system, the control device is arranged to have a warning device which generates and issues a warning when the transmission channel length as sent from the transmission channel length detector is in excess of a predetermined length.

Additionally in the transmission system, the test signal is a signal with its transfer rate being less than a transfer rate during operation of the system.

The interexchange device is arranged to transfer delay time information obtainable from the second delay time detector toward the control device while letting the information be attached to a utility region of the sendback signal.

As apparent from the foregoing, in accordance with this invention, it is possible to achieve the high-reliability signal transmission system with its ability to transfer a camera-shot image(s) without fail. It is also possible to recognize the length of a transfer channel and display a present status of such transfer channel with or without its relevant information. For example, a warning message is displayable for additional installation of an interexchange device, also known as repeater, while displaying the information as to a location whereat the repeater is added. This ensures that an operator is able to make use of the system in good conscience.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram schematically showing a configuration of a two-way signal transmission system in accordance with one embodiment of the present invention.

FIG. 2 is a timing chart for explanation of an operation of the transmission system shown in FIG. 1.

FIG. 3 illustrates, in block diagram form, an internal configuration of a camera head unit as used in the system.

FIG. 4 depicts in block diagram form a configuration of a repeater device in the embodiment system.

FIG. 5 is a block diagram showing a configuration of a camera control unit (CCU) in the system.

FIG. 6 is a waveform diagram for explanation of a delay time occurrable in the system.

FIGS. 7A and 7B are diagrams for explanation of a test signal employable in the embodiment system.

FIG. 8 is a diagram for explanation of another embodiment of this invention.

FIGS. 9A to 9C are diagrams each showing an exemplary on-screen message as displayed on a monitor.

### DETAILED DESCRIPTION OF THE INVENTION

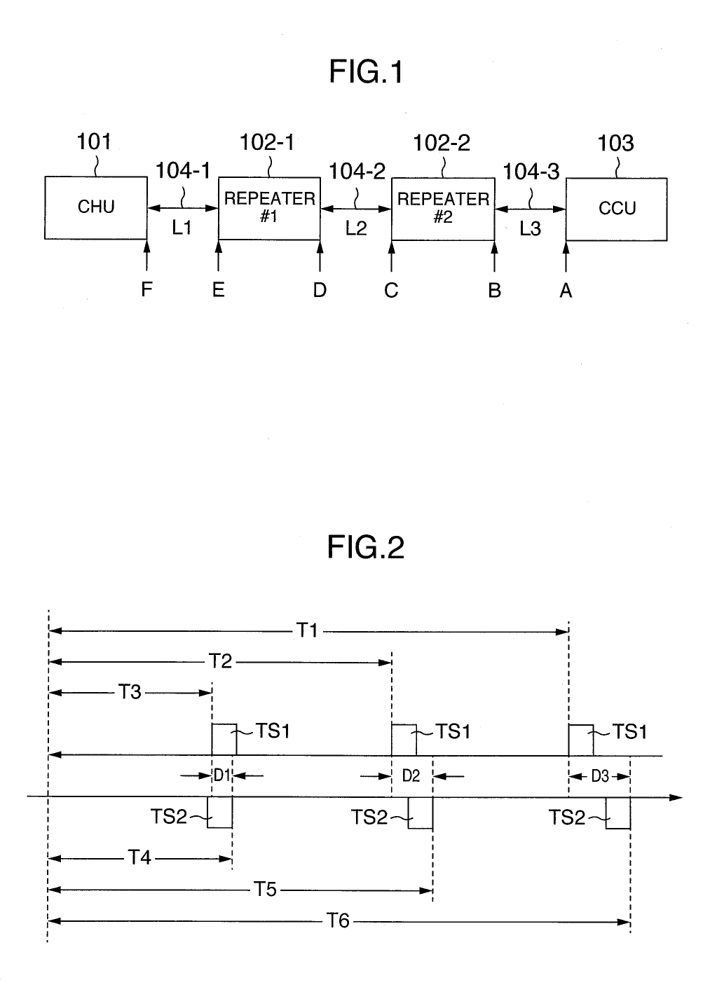

Currently preferred embodiments of this invention will be described with reference to the accompanying drawings below. FIG. 1 depicts, in block diagram form, a bidirectional signal transmission system embodying the invention. In FIG. 1, reference numeral 101 designates an imaging device—here, a camera head unit—for shooting scenes and objects or subjects. This camera head unit 101 is operatively connected to a control device 103 through interexchange devices, i.e., repeaters 102-1 and 102-2. Although in this embodiment two repeater devices are provided, these may be replaced by one repeater or three or more repeaters on a case-by-case basis. Note here that in the description below, the repeaters 102-1 and 102-2 will be collectively called the repeater 102 when deemed appropriate in a way depending upon the context of the description. The control device 103 may illustratively be a camera control unit (CCU). The camera head 101 is linked to repeater 102-1 via a triaxial (“triax”) cable 104-1, which in turn is coupled to the next stage of repeater 102-2 by a triax cable 104-2. This repeater 102-2 is linked to CCU 103 by a triax cable 104-3. These triax cables 104-1 to 104-3 will be collectively called the triax cable 104 for the purpose of convenience of explanation.

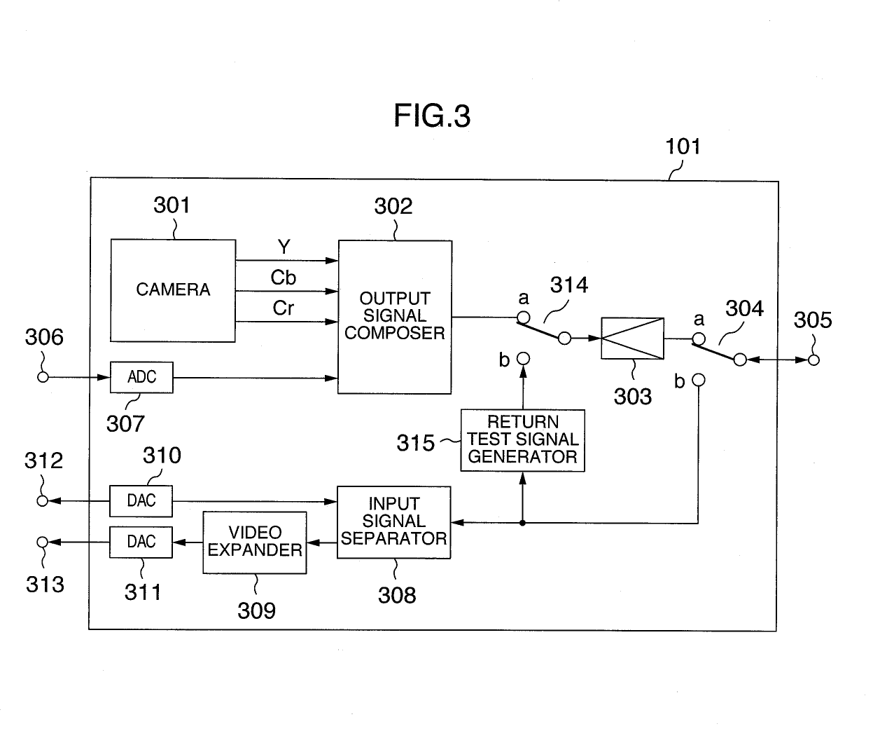

An explanation will next be given of practically implemented configurations of the camera head unit 101, the repeater 102 and CCU 103 with reference to FIGS. 3 to 5 below. FIG. 3 is a block diagram showing a detailed configuration of the camera head unit 101. As shown herein, camera head 101 includes a camera unit 301. This camera has a solid-state image pickup device, such as a charge coupled device (CCD) image sensor module, and functions to shoot scenes and/or objects for generating at its output an electrical video signal. In this embodiment, for example, the video signal is separated into a luminance signal Y, a blue color difference signal Cb and a red color difference signal Cr, which are supplied to an output signal combining unit 302 for production of a composite color video signal. This signal is then sent from an input/output (I/O) terminal 305 to CCU 103 of FIG. 1 via a changeover switch 304, also known as transfer switch. The luminance signal Y and the blue/red color difference signals Cb, Cr are converted in camera 301 to digital signals, respectively. An input terminal 306 is for receiving a sound signal indicative of audio/voice and music sounds or else (referred to as audio signal hereinafter) as sent from a microphone (not shown). The input audio signal is converted by an analog-to-digital converter (ADC) 307 into a digital audio signal, which is combined together with the composite color video signal for transmission to CCU 103. In the description below, the composite color video signal contains therein an audio signal(s) also.

A composite color video signal to be sent back or returned from CCU 103 is supplied from the I/O terminal 305 to an input signal separation unit 308 through the transfer switch 304. This input signal separator 308 separates the composite color video signal into a video signal and an audio signal. The video signal is supplied to a video image expander 309 for expanding or “stretching” the compressed video signal, which is then passed to a digital-to-analog converter (DAC) 311 for conversion to an analog signal to be supplied from an output terminal 313 to a monitor display device. Regarding the audio signal from the input signal separator 308, this signal is converted by a DAC 310 into an analog audio signal, which is then supplied to a speaker module of the monitor or else. Additionally the switch 314 functions to switch between signal transfer paths, one of which is for supplying the composite color video signal from the output signal combiner 302 to the I/O terminal 305, and the other of which permits a returned composite color video signal from I/O terminal 305 to be fed to the input signal separator 308. Switch 314 functions as a signal sendback means for performing switching of a return test signal that is generated by a return test signal generator circuit 315, which signal contains test signal information to be sent from CCU 103 and information on the camera head unit 101 side, and for sending it back to CCU 103 via an amplifier unit 303 in a way to be later described. The test signal may be either a video signal or a non-video signal as will be described in detail later.

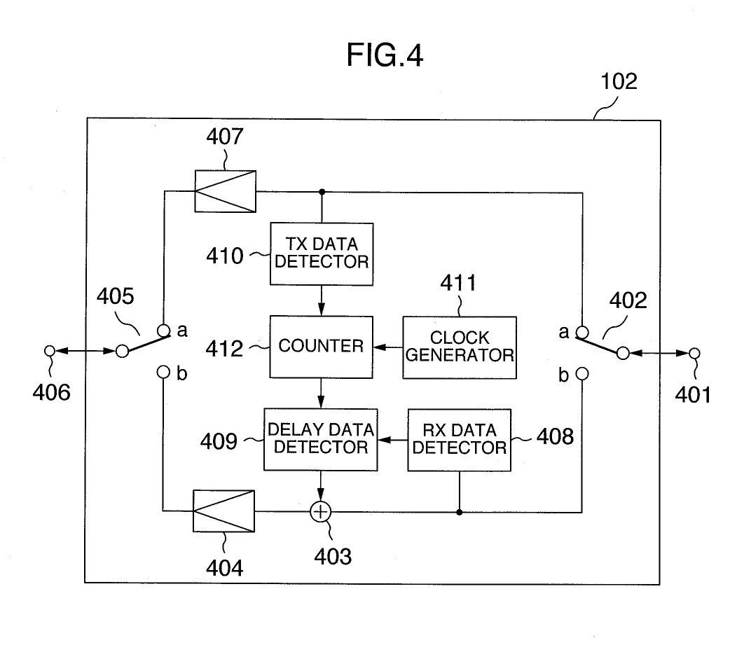

FIG. 4 is a block diagram showing an internal configuration of the repeater device 102. As shown herein, the repeater 102 has an I/O terminal 401 for receiving the composite color video signal from the camera head unit 101, which signal is then supplied via a switch 402 and adder 403 to an amplifier unit 404. This amplifier 404 applies amplification and wave-shaping to the input composite color video signal. The resultant signal is output from an I/O terminal 406 via a switch 405 to another repeater device on the post stage or alternatively to CCU 103. A return composite color video signal as sent back from the post-stage repeater or CCU is supplied from the I/O terminal 406 via switch 405 to an amplifier 407. The amplifier 407 applies amplification and wave-shaping to the input return composite color video signal, causing the resulting signal to be output from I/O terminal 401 via switch 402 to camera head unit 101. In brief, the repeater device 102 functions as the so-called digital signal repeater which amplifies and wave-shapes the composite color video signal and the return composite color video signal to be sent via its associated triax cable 104.

This repeater device 102 further includes a received data detection unit (referred to as first received data detector) 408, a delay data detection unit (first delay data detector) 409, a transmit data detection unit (first transmit data detector) 410, a clock generator unit 411 and a counter 412. Each of the functional units (these constitute a second delay time detector means) is provided to automatically detect a delay time of the triax cable 104, which is one of the principal features of this invention. Operations of these functional units are as follows. The receive (Rx) data detector 408 detects the timing of a signal as input to amplifier 404. The transmit (Tx) data detector 410 detects the timing of a signal as output from amplifier 407. The clock generator 411 generates a clock signal which is synchronized with a clock signal from a clock generator of CCU 103 to be described later and which is for use as a reference signal that determines the measured timing of each signal. The counter 412 is for detection of a delay time between the Rx data detector 408 and Tx data detector 410. The delay data detector 409 detects a delay amount and generates a delay detection signal in a predetermined format to be later described, which signal is added by the adder 403 to a transfer signal for transmission to CCU 103. This delay time detection will be described in detail later.

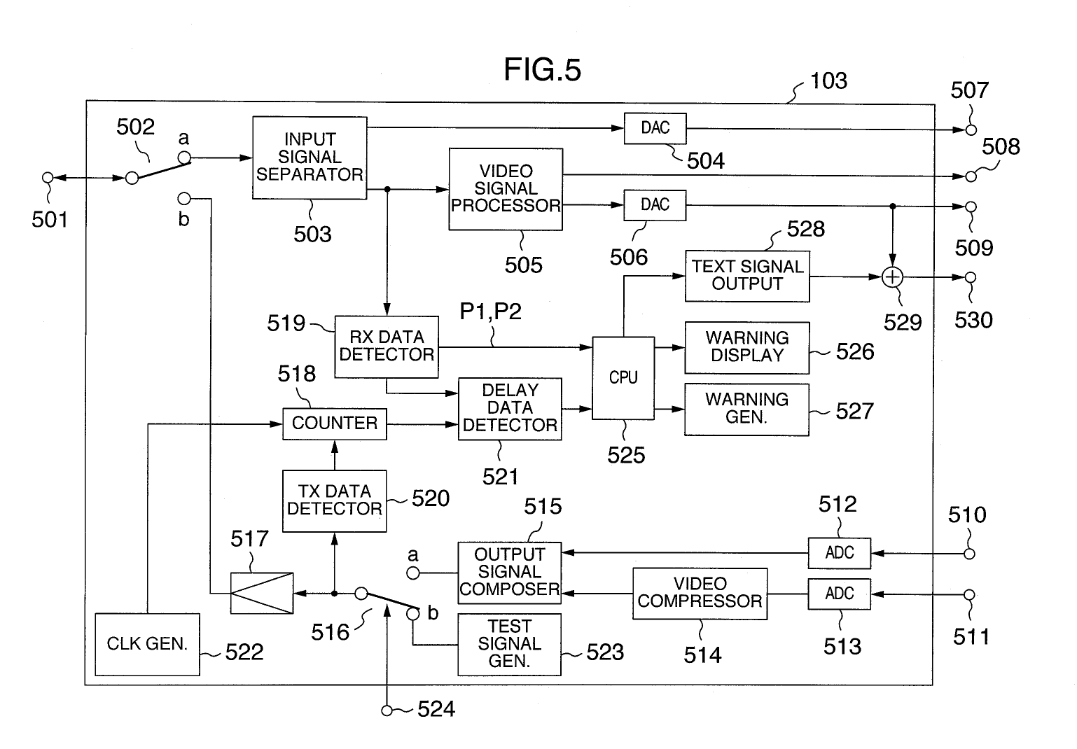

FIG. 5 is a block diagram showing a detailed configuration of the CCU 103. As shown herein, CCU 103 has an I/O terminal 501 for receiving the composite color video signal as sent from the repeater device 102, which signal is then supplied to an input signal separator 503 via a switch 502. At input signal separator 503, the signal as sent thereto is separated into a composite color video signal and audio signal. The audio signal is converted by a DAC 504 into an analog signal, which is output from an output terminal 507 and is applied with prespecified signal processing for transmission to a TV broadcast station (not shown), as an example.

The composite color video signal from the input signal separator 503 is passed to a video signal processor 505 and applied specific signal processing thereby and then output from an output terminal 508 as a digital color video signal for transmission to the broadcast station, for example. The output signal of processor 505 is also supplied to a DAC 506 for conversion to an analog video signal, which is output from an output terminal 509 and then sent forth to the broadcast station after having applied thereto predetermined signal processing. Video images are displayed on a monitor (not shown) when the need arises.

CCU 103 has an input terminal 510 for receiving an audio signal to be sent back or returned to the camera head unit 101, which signal is converted by an ADC 512 into a digital signal and then fed to an output signal composing unit 515. CCU 103 has another input terminal 511 for receiving a returned composite color video signal, which is converted by an ADC 513 into a digital signal and then compressed at a video compressor unit 514 and thereafter supplied to the output signal composer 515. The video compressor 514 is arranged to have its transfer frequency band which is wide enough to enable transmission of the compressed video signal from the camera head unit 101 to CCU 103 in view of the fact that the return composite color video signal is satisfactorily about 70 Mbps in data rate as stated previously. The output signal composer 515 combines or “synthesizes” together the returned audio signal and the return composite color video signal to thereby generate a combined signal, which is sent from the output terminal 501 to the camera head unit 101 through a switch 516 and an amplifier 517 plus the switch 502.

The CCU 103 also has its function of measuring a transfer signal delay time while displaying the measured delay time: this function is a feature unique to this invention, as will be described below. CCU 103 includes a received data detection unit (referred to as second Rx data detector) 519, a transmit data detection unit (second Tx data detector) 520, a delay data detection unit (second delay data detector) 521, and a clock generator unit 522 for generating a clock signal of this signal transmission system. The above-stated camera head unit 101 and repeater device 102 operate in a way synchronous with the clock signal from this clock generator 522. The delay data detector 521 is responsive to receipt of those signals from the Rx data detector 519 and Tx data detector 520, for detecting delay information and then passing it to a central processing unit (CPU) 525. CPU 525 performs arithmetic processing based on the delay information from delay data detector 521 for driving a warning display unit 526 to visually display a warning message(s) on its screen, for driving an alarm generator 527 to produce alarm sounds, and for driving a character signal output unit (i.e., text generator) 528. An output signal of the text generator 528 is added at an adder 529 to the analog video signal from DAC 506 and is then output from an output terminal 530 for enabling warning information to be displayed on the monitor (not shown) together with video images. Additionally, the second Rx data detector 519, second Tx data detector 520, second delay data detector 521, CPU 525, clock generator 522 and a counter 518 make up a first delay time detecting module.

CCU 103 includes a test signal generator 523 to be later described and a switching signal input terminal 524 for receiving a control signal as input thereto. In response to this control signal, a switch 516 is selectively connected to either one of contact nodes “a” and “b” thereof. When switch 516 is connected to the node a side, an output signal of the output signal combiner 515 is supplied to amplifier 517; alternatively, when switch 516 is coupled to the node b side, an output of the test signal generator 523 is fed to amplifier 517.

A detailed explanation will next be given of a method for detecting a present transfer state of the bidirectional signal transmission system embodying the invention with reference to FIGS. 2 and 6-9 below. Note that the data rate—typically, this refers to the data transfer rate during operation of this system—for two-way transmission of a video signal of scene images as shot by the camera unit 301 in the illustrative embodiment is set at about 270 Mbps as in prior art signal transfer systems. Recall here that when using this data rate of 270 Mbps, the optimum transfer distance is about 700 m. Thus, the use of such 270 Mbps data rate would result in lack of an ability to detect the transfer state of a triax cable with its length of 1 km or more. In light of this fact, the illustrative embodiment is arranged to perform, prior to startup of a TV broadcast program (i.e., before system activation), detection of the transfer state of the signal transmission system by use of a test signal at a data rate lower than that upon initial activation of the system. Preferably this data rate of the test signal that is less in deterioration is lower than the data rate (70 Mbps) of the sendback signal—for example, 7 Mbps. In other words, the test signal data rate is set to about 1/40 of 270 Mbps. When sending such signal at the data rate of 7 Mbps by a triax cable, the signal attenuation is approximately −25 dB/km. This enables signal transmission at a distance of about 3 km as the signal attenuation of 3 km-long triax cable is about −75 dB. This is a sufficient length for detection of the transfer state of such triax cable. Accordingly, the above-noted test signal as output from the test signal generator 523 is a signal with its data rate of 7 Mbps. It is noted that although in this embodiment the 7 Mbps data rate signal is used as the test signal, this is not restrictive of the invention and may obviously be modified depending on the length of a triax cable being measured, on a case-by-case basis.

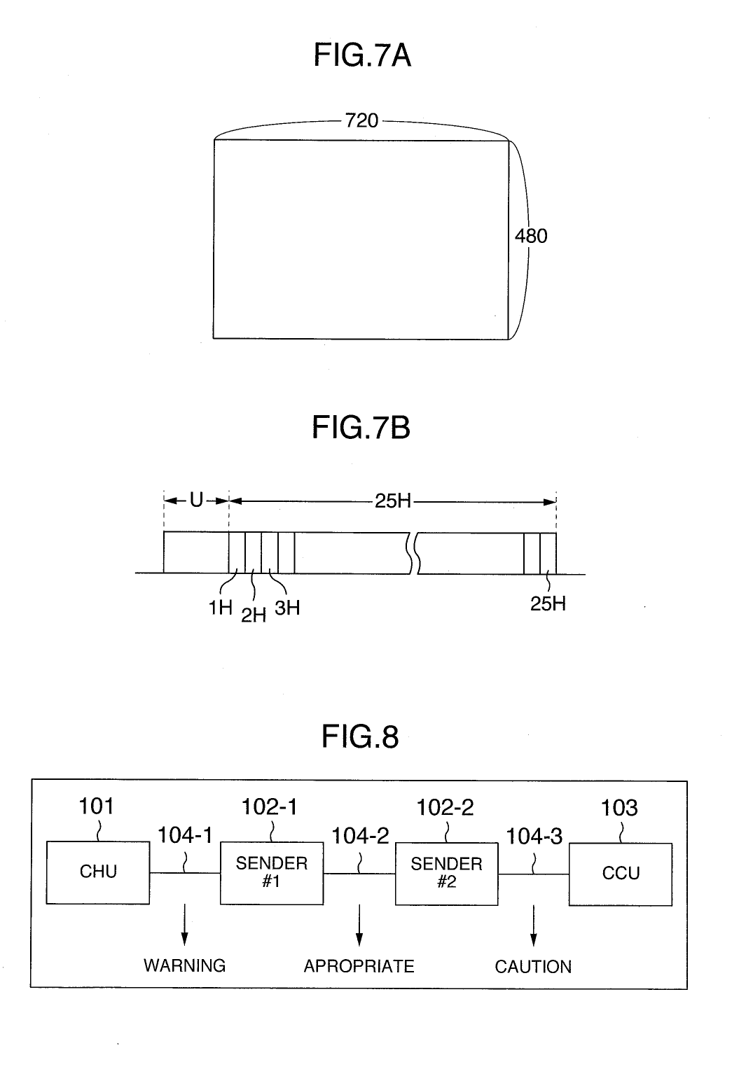

An explanation will first be given of the 7 Mbps data-rate signal for use as the test signal. FIGS. 7A and 7B show an exemplary signal format in the event that a TV broadcast signal pursuant to the national television system committee (NTSC) standards is transferred in the form of a digital signal. FIG. 7A shows a video signal with a matrix of 720 by 480 picture elements or “pixels,” as an example. FIG. 7B shows a signal format for transmission of the video signal of FIG. 7A. NTSC video signals are interlaced so that one frame (720×720 pixels) consists of two fields each having 720×240 pixels. An image of one field is transferred as a digital signal that is divided into 25 blocks per horizontal scanning period H—i.e., 25H.

In FIG. 7B, a region U is a utility area which is provided for transfer of the information data of 25H. This utility region U is capable of containing therein 256 items of 10-bit data, i.e., 2,560 bits of data, for example. The utility region U is followed by a data region of 25H which is constituted from respective data of 1H (digital data of first scanning line), 2H (digital data of second scanning line), . . . , 25H (digital data of 25th scan line). Therefore, in the case of performing detection of a present transfer state of the signal transmission system, what is to be done first is that an operator manually operates an operation unit (not shown) so that a control signal is input from the input terminal 524 to thereby connect the switch 516 to its node b side. Whereby, a send test signal from the test signal generator 523 is passed via amplifier 517 and switch 502 to I/O terminal 501, from which the signal is output and sent to the camera head unit 101 through repeater device 102. At camera head 101, the send test signal is input from I/O terminal 305 via switch 304 to the send test signal generator circuit 315, which generates a sendback test signal that contains therein the information of send test signal from CCU 103 and the information of the camera head 101 side. This signal is then supplied to amplifier 303 via switch 314 over the transfer channel of composite color video signal, followed by returning as a reception test signal from I/O terminal 305 via repeater device 102 to CCU 103. It readily occurs to a skilled person that the control of changing over the switch 516 to its terminal b side is not exclusively limited to the process of causing the operator to manually operate the operation unit for receipt of the control signal from input terminal 524 and may alternatively be modified so that control is provided, by CPU 525 in a specific situation such as upon activation of CCU 103, to change the switch 516 to its terminal b to thereby perform the detection of the transfer state of the signal transmission system in an automated way. Note here that in the description below, the signal shown in FIG. 7B will be called the test signal TS.

The test signal generated by the test signal generator 523 in CCU 103 of FIG. 5 is supplied to the switch 502 via amplifier 517 when switch 516 is changed over to its node b side in response to receipt of an input signal from the switching signal input terminal 524. The switch 502, to which I/O terminal 501 of CCU 103 is connected, performs time-multiplexed switching between its nodes a and b in a similar way to the events of input and output of the composite color video signal from camera head unit 101 even upon inputting and outputting of the test signal. Similarly, a respective one of the switches 402 and 405 which are connected to I/O terminals 401 and 406 of repeater device 102 and the switch 304 that is coupled to I/O terminal 305 of camera head unit 101 operates to perform switching between the terminal a and b thereof. Note here that regarding the switch 314 of camera head 101, this switch is arranged to provide in the sendback test signal generator 315 an appropriate control circuit for detection of the test signal, which detects its header pattern upon inputting of the test signal from I/O terminal 305 to thereby fix switch 314 to its node b side, thus permitting the test signal to be transferred at any events to the CCU 103 side through amplifier 303.

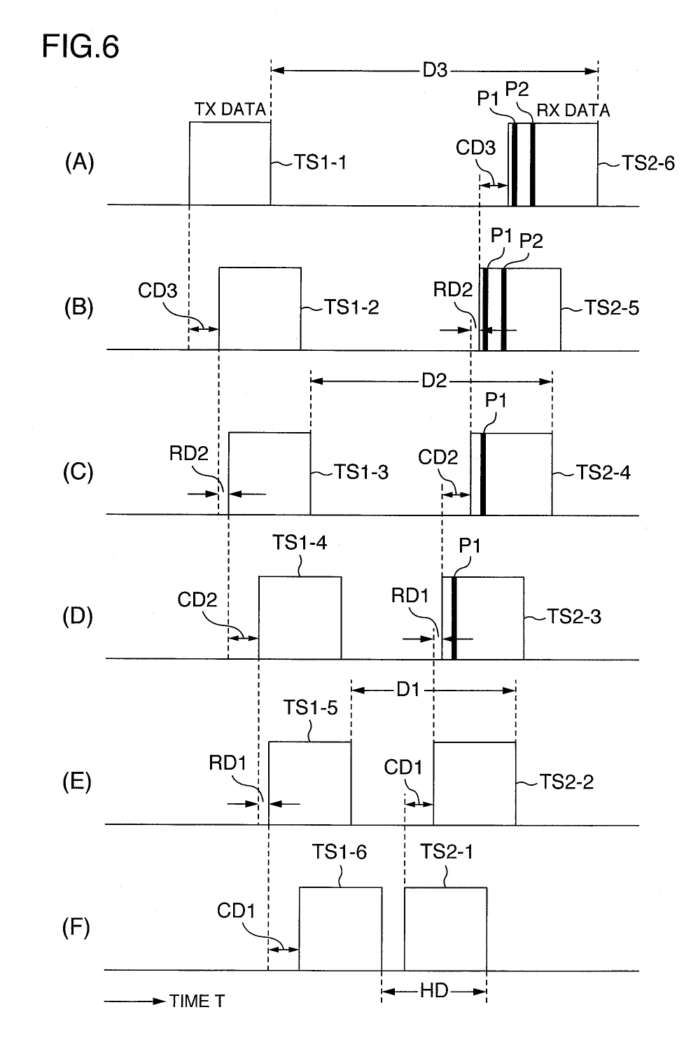

Next, an explanation will be given of the transfer state of the test signal TS with reference to FIGS. 2 and 6 below. In FIG. 2, T1 designates a time as taken for the test signal TS1 transmitted from CCU 103, called the send test signal, to arrive at the camera head unit 101; T2 is a time period between a time point immediately after its passing though repeater device 102-2 and a time point whereat it reaches camera head unit 101; and, T3 is a time period between a time point immediately after its passing though repeater device 102-1 and an instant whereat it reaches camera head 101. In addition, T4 is a time period between a time point at which a test signal TS2 for sending back to CCU 103 from camera head 101 (this is also called a reception test signal or, alternatively, sendback signal) is output from camera head 101 and a time point immediately after it passed through repeater device 102-1, T5 is a time period between the instant at which the signal is output from camera head 101 and an instant immediately after its pass-through of repeater device 102-2, and T6 is a time period between the instant whereat the signal goes out of camera head 101 and an instant that it arrives at CCU 103.

In the case of the test signal TS being transferred over a transmission channel (triax cable), a signal delay can take place. Examples of this signal delay include, but not limited to, a delay due to the length of the transfer channel (cable), a delay due to the signal processing within the repeater device(s), and a delay due to the signal processing within the camera head unit per se. The signal delay time and the delay due to transfer path length are in a proportional relationship. The delays at the repeater device(s) and camera head are each kept constant in value and thus are determinable in advance by either measurement or calculation. Respective cable connection points of the CCU 103, repeater devices 102-1 and 102-2 and camera head 101 are indicated by A, B, C, D, E and F as shown in FIG. 1. A relationship between the send test signal TS1 and reception test signal (sendback signal) TS2 of the test signal TS at this time will be described using FIG. 6. Note that the test signal TS shown in FIG. 6 indicates the utility region U of test signal shown in FIG. 7B.

In FIG. 6, its transverse axis indicates the time T. Part (A) of FIG. 6 shows a transmit (Tx) test signal TS1-1 at the point A along with a receive (Rx) test signal TS2-6. A time difference (delay time) at this time is D3. Part (B) of FIG. 6 shows a Tx test signal TS1-2 at the point B along with Rx test signal TS2-5. A time difference CD3 between Tx test signals TS1-1 and TS1-2 is a delay time due to signal transfer of triax cable 104-3. Similarly, a time difference between Rx test signals TS2-5 and TS2-6 becomes the delay time CD3 due to the signal transfer of cable 104-3. Additionally, part (C) of FIG. 6 shows a Tx test signal TS1-3 and Rx test signal TS2-4 at the point C. A time difference (delay time) at this time is D2. A time difference RD2 between Tx test signals TS1-2 and TS1-3 represents a delay time based on the processing within the repeater device 102-2. Similarly, a time difference between Rx test signals TS2-4 and TS2-5 also becomes the delay time RD2 based on the signal processing in repeater device 102-2. Note that this delay time RD2 takes place due to the signal processing in repeater 102-2 and is obtainable in advance through measurement or computation.

Part (D) of FIG. 6 shows a Tx test signal TS1-4 and Rx test signal TS2-3 at the point D. A time difference CD2 between the Tx test signals TS1-3 and TS1-4 represents a delay time due to the signal transmission of cable 104-2. Similarly a time difference between the Rx test signals TS2-3 and TS2-4 also becomes the delay time CD2 due to the signal transfer of cable 104-2. In addition, part (E) of FIG. 6 shows a Tx test signal TS1-5 and Rx test signal TS2-2 at the point E. A time difference (delay time) at this time is D1. A time difference RD1 between the Tx test signals TS1-5 and TS1-4 represents a delay time based on the signal processing in repeater device 102-1. Similarly a time difference between Rx test signals TS2-2 and TS2-3 also becomes the delay time RD1 based on the signal processing in repeater 102-1. Note here that this delay time RD1 occurs due to the signal processing in repeater 102-1 and is predeterminable by measurement or computation.

Part (F) of FIG. 6 shows a Tx test signal TS1-6 and Rx test signal TS2-1 at the point F. A time difference CD1 between the Tx test signals TS1-5 and TS1-6 represents a delay time due to the signal transfer of cable 104-1. Similarly a time difference between Rx test signals TS2-1 and TS2-2 also becomes the delay time CD1 due to the signal transfer of cable 104-1. Additionally, a time difference HD between Tx test signal TS1-6 and Rx test signal TS2-1 indicates a delay time based on the processing for sending back the test signal to be done in the camera head unit 101. This delay time HD is obtainable in advance by measurement or computation.

Next, a detailed explanation will be given of a technique for obtaining the delay time of each cable. In the process of obtaining a delay time at the repeater device 102, Tx data detector 410 detects a time immediately after Tx test signal TS1 passed through repeater device 102 as has been stated previously in conjunction with FIG. 4, whereas Rx data detector 408 detects a time immediately before Rx test signal TS2 passes through repeater 102. Thus, the delay time D1 of test signal TS at point E is represented by:

D1=CD1+HD+CD1. (1)

Accordingly, the length L1 of cable 104-1 is given as:

L1=K×((D1−HD)/2), (2)

where K is the coefficient of proportionality indicating a relationship of cable length versus delay time.

As the delay time of Tx/Rx data at the point D is added delays due to cable 104-1 and repeater device 102-1, the delay time at point D is finally given as D1+RD1. This delay time is obtainable by causing counter 412 to count a time difference relative to test signal detection at Rx data detector 408 and Tx data detector 410. The information of this delay time D1+RD1 is sent forth while being attached to the utility region U when sending Rx data TS2 from the point D to point C. More specifically, as shown in (D) of FIG. 6, the delay time information indicated by P1 is attached to the utility region U.

As for the delay time D2 of test signal TS at point C, this is represented by:

D2=CD2+RD1+D1+RD1+CD2. (3)

Thus, the length L2 of cable 104-2 is given by:

L2=K×((D2−D1−2·RD1)/2), (4)

where K is the proportionality coefficient indicative of the relationship of cable length versus delay time, and RD1 is the delay time of repeater device 102-1.

The delay time of Tx/Rx data at point B is equal to D2+RD2 due to the delay of Tx/Rx data at point C and the delay time due to repeater device 102-2. When sending Rx data TS2 from the point B to A, the information of this Tx/Rx data delay time (D2+RD2) at point B is attached to the utility region U for transmission. In other words, as shown in (B) of FIG. 6, the delay time information indicated by P2 is added to utility region U. Note that in the case of transmission with the information contained in the utility region U, this information may be added to another utility region U if it is detected that the former region is already filled with the above-stated delay information P1 attached thereto. In (B) of FIG. 6, there is shown a state with the delay time information P1 and P2 being attached.

The delay time D3 of test signal TS at the point A is represented as:

D3=CD3+RD2+D2+RD2+CD3. (5)

The length L3 of cable 104-3 is given by:

L3=K×((D3−D2−2·RD2)/2, (6)

where K is the proportionality coefficient indicating the relationship of cable length versus delay time, and RD2 is the delay time of repeater device 102-2.

Thus, a total cable length L spanning between CCU 103 and camera head unit 101 is defined as:

L=L1+L2+L3. (7)

Accordingly, the CPU 525 of CCU 103 determines or “detects” through numerical computation the optimum length of each cable 104-1, 104-2, 104-3 by use of the delay time information P1, P2 as added to the utility region(s) U of received data and the delay time D3 between CCU 103 and camera head 101 as sent from delay data detector 521. The total cable length L is also obtainable. CPU 525 includes a transfer path length detection module for executing arithmetic processing to obtain the transfer path length based on a prespecified assembly of software program routines.

In this way, the test signal of 7 Mbps data rate is used to measure the cable length and delay time(s). Exemplary measured values of delay time and attenuation relative to the length of triax cable length as used in the embodiment system are shown in Table 1 below.

TABLE 1

| | Transfer | | | |
|---|---|---|---|---|
| | Rate of | | Transfer | |
| | 270 Mbps | | Rate of | |
| Cable | Delay | | 7 Mbps | |
| Length | Time | Attenuation | Delay | Attenuation |
| (m) | (ns) | (dB) | Time (ns) | (dB) |
| 1,000 | 5,000 | −170 | 5,000 | −27 |
| 700 | 3,500 | −119 | 3,500 | 19 |

Table 1 shows several measured delay time and attenuation values for the transfer rate of 270 Mbps and for transfer rate of 7 Mbps (test signal) in the case of the cable length being set at 1,000 meters (m) and 700 m. As previously stated, the individual triax cable used must be less than or equal to 700 m in length because of the fact that a more than 700 m-long triax cable can experience a large amount of attenuation, resulting in the lack of an ability to properly reproduce digital signals. Thus, a threshold value Dth of delay time to be obtained by the above-stated method from Equation (1), (3), (5) is set to 3,500 nanoseconds (ns). When exceeding this value, it is determined that the triax cable must be 700 m or greater in length. Thus, it becomes possible by inserting repeater device 102 at this part to attain the data transmission at a distance of 700 m or longer. Additionally determining the cable length from the delay time is easy because the cable length is proportional to the delay time.

As described above in detail, it becomes possible to measure the cable length between respective devices by arranging each repeater device 102 and CCU 103 to have the function of detecting a timing error between Tx and Rx test signals and by transferring the delay time information between respective devices toward CCU 103 while letting it be attached to the utility region(s) U. It should be noted that the test signal used in the above-noted embodiment may be replaced by a test signal as sent from the test signal generator, a video signal indicative of scene images as sensed by the imager device with appropriate image processing applied thereto, or other similar suitable signals. Obviously, the test signal generator is omissible when the video signal is used as the test signal in a case-sensitive way. The video signal is sent with a time reference signal (TRS) added thereto for time management upon detection of this TRS on the receiver side. TRS is also employable for the measurement of a delay time.

FIG. 8 is a diagram for explanation of another embodiment of this invention, wherein a pictorial image of signal transfer system is displayed on the screen of a monitor display device for indicating a present state of it. Specifically, this shows the state as displayed on a display device (not shown) that is connected to the output terminal 530 of CCU 103. In FIG. 8, the camera head unit 101, transfer devices 102-1 and 102-2 and CCU 103 are connected by respective cables 104-1 to 104-3, with the above-noted measurement results being displayed at portions of the cables in the form of several messages of “Warning” (the cable length exceeds 700 m), “Optimum” (cable length is within 700 m, for example, 300 m) and “Notice” (cable length is almost 700 m). Such message display is readily achievable by letting CPU 525 be programmed in advance. The above-noted “Notice” message is promptly displayable without difficulty whenever the cable length is within a range of about 600 m to 700 m, for example.

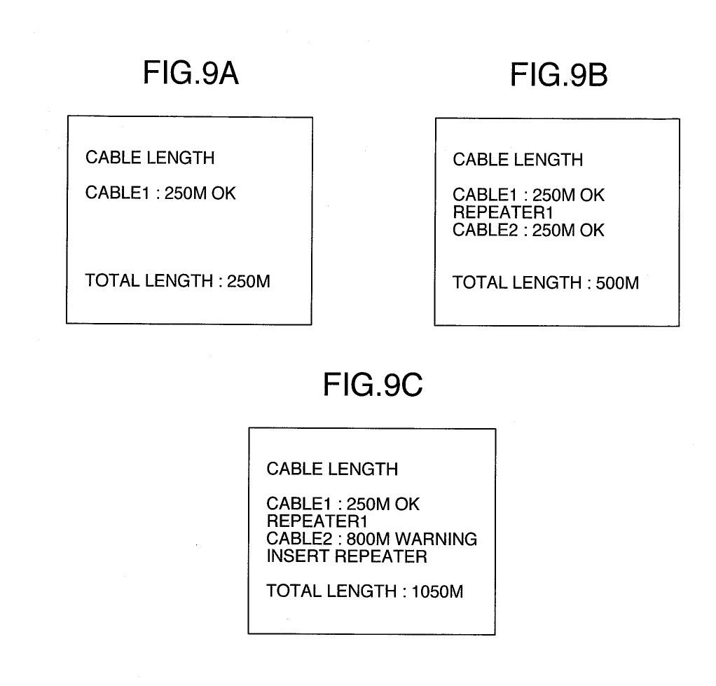

FIGS. 9A to 9C are diagrams for explanation of a further embodiment of this invention, wherein each shows a message such as a warning to be displayed on the monitor screen. More specifically, FIG. 9A shows an exemplary on-screen message saying that the cable length is 250 m, the total cable length is also 250 m, and signal transfer system setup is normal. FIG. 9B shows a message saying that the cable 104-1 is 250 m long and proper, one repeater device 102-1 is presently installed, the cable 104-2 is 250 m long and proper, and the total cable length is 500 m and proper. FIG. 9C shows a message saying that the cable 104-1 is 250 m long and proper, one repeater device 102-1 is installed, the cable 104-2 is 800 m long with a warning given thereto, and the total cable length is 1,050 m with a suggestion for the necessity to insert a repeater device. Accordingly, looking at the display of FIG. 9C, the operator becomes aware of the fact that the cable 104-2 is too long so that he or she can instruct the insertion of a repeater in the cable 104-2.

Although in the illustrative embodiment two repeater devices are used in the transfer system, the cable length between respective devices is also measurable by similar methodology even when more than two repeaters are used. In addition, even in the absence of such repeater devices, the processing is still executable, including detecting the length of a transfer path between CCU 103 and camera head unit 101 by the method, displaying the transfer path length, and issuing a warning whenever exceeding a predetermined length. Thus, this invention should not exclusively be limited to the embodiment with more than one repeater devices being provided therein.

While this invention has been particularly shown and described with reference to specific embodiments thereof, it will be understood by those skilled in the art that the invention should not be limited to the embodiments of the digital signal transmission system and warning information display method for use therein and may be widely applicable to other signal transfer systems and warning information display methods. Although the explanation of embodiments above exemplifies triaxial or “triax” cable transmission, the bidirectional signal transmission system is also realizable by using a configuration with the I/O switch between adjacent ones of the camera head unit, repeater device(s) and CCU being replaced by a pair of input- and output-dedicated ports while employing interconnection of two-line cables at upstream and downstream private lines in a way pursuant thereto.

It should be further understood by those skilled in the art that although the foregoing description has been made on embodiments of the invention, the invention is not limited thereto and various changes and modifications may be made without departing from the spirit of the invention and the scope of the appended claims.

1. bidirectional signal transmission system comprising:
an imaging device;
a control device for control of the imaging device; and
a transmission channel for connecting the imaging device and the control device, wherein
said imaging device includes signal send-back means for inputting a test signal as output from the control device and for sending the test signal back to the control device, and said control device includes first delay time detection means for detecting a delay time of from outputting of the test signal to inputting of the signal as sent back thereto.

2. A bidirectional signal transmission system according to claim 1, further comprising:
at least one interexchange device having second delay time detection means for detecting a delay time between outputting of the test signal from said interexchange device toward said imaging device and inputting of the send-back signal to said interexchange device.

3. A bidirectional signal transmission system according to claim 1, wherein said control device has transmission channel length detection means for detecting a length of the transmission channel based on at least delay time information from said first delay time detection means.

4. A bidirectional signal transmission system according to claim 3, wherein said control device further includes display means for displaying the length of the transmission channel based on an output of the transmission channel length detection means.

5. A bidirectional signal transmission system according to claim 3, wherein said control device further includes warning means for issuing a warning when the length of the transmission channel as sent from said transmission channel length detection means is in excess of a predetermined length.

6. A bidirectional signal transmission system according to claim 1, wherein the test signal is a signal with its transfer rate being less than a transfer rate during operation of the bidirectional signal transmission system.

7. A bidirectional signal transmission system according to claim 2, wherein said interexchange device transfers delay time information obtainable from said second delay time detection means toward said control device while letting the information be attached to a utility region of the send-back signal.
